(19) United States
(12) Patent Application Publication
(10) Pub. No.: US 2019/0066502 A1
(43) Pub. Date: Feb. 28, 2019

(54) METHOD AND SYSTEM FOR ASSISTING VEHICLE PARKING

(71) Applicant: GM GLOBAL TECHNOLOGY OPERATIONS LLC, Detroit, MI (US)

(72) Inventors: Xinyu Du, Oakland Township, MI (US); Praveen Palanisamy, Sterling Heights, MI (US); Bo Yu, Troy, MI (US); Prathap Venugopal, Troy, MI (US); Tian Ni, Rochester Hills, MI (US); Vivek Vijaya Kumar, Shelby Township, MI (US); Paul E. Krajewski, Troy, MI (US)

(21) Appl. No.: 15/685,360

(22) Filed: Aug. 24, 2017

(51) Int. Cl. G08G 1/14; G07B 15/02; G06Q 10/00

(52) U.S. Cl. CPC G08G 1/142; G06Q 10/00; G08G 1/147; G07B 15/02

(57) ABSTRACT

A system and method for assisting vehicle parking is disclosed. The method includes transmitting, by an electronic controller of a vehicle, a parking space request. The parking space request is transmitted to a reservation system. The reservation system determines whether a parking space is available to fulfill the parking space request. The determining is based on availability information that is received from a parking infrastructure. The method also includes receiving an indication. The indication indicates whether a parking spot has been reserved to fulfill the parking space request.

The subject embodiments relate to assisting vehicle parking. Specifically, one or more embodiments assist vehicles in finding available parking spaces and/or assist vehicles in reserving parking spaces, for example.

A parking space is a cleared area that is intended for a vehicle to be stopped and left unoccupied within. The space can be defined by lines drawn on a road surface. When parking a vehicle in a parking space, the owner of the vehicle may need to pay a specified fee in order to occupy the parking space, or the time allowed to park the vehicle within the parking space may be limited to a specified time.

### SUMMARY

In one exemplary embodiment, a method includes transmitting, by an electronic controller of a vehicle, a parking space request. The parking space request is transmitted to a reservation system. The reservation system determines whether a parking space is available to fulfill the parking space request. The determining is based on availability information that is received from a parking infrastructure. The method also includes receiving an indication. The indication indicates whether a parking spot has been reserved to fulfill the parking space request.

In another exemplary embodiment, the transmitting the parking space request includes transmitting a destination of the vehicle.

In another exemplary embodiment, the transmitting the parking space request includes transmitting information about the size of the vehicle.

In another exemplary embodiment, the availability information is received from a parking infrastructure that includes parking sensors.

In another exemplary embodiment, the method also includes transmitting payment information from the vehicle for occupying the available parking space.

In another exemplary embodiment, the parking infrastructure corresponds to infrastructure of at least one of a parking lot, a parking garage, a parking meter, and a street surveillance system.

In another exemplary embodiment, the method also includes activating a mechanism to prevent others from occupying a reserved parking spot.

In another exemplary embodiment, a system within a vehicle includes an electronic controller configured to transmit a parking space request. The parking space request is transmitted to a reservation system. The reservation system determines whether a parking space is available to fulfill the parking space request. The determining is based on availability information that is received from a parking infrastructure. The electronic controller is also configured to receive an indication. The indication indicates whether a parking spot has been reserved to fulfill the parking space request.

In another exemplary embodiment, the transmitting the parking space request includes transmitting a destination of the vehicle.

In another exemplary embodiment, the transmitting the parking space request includes transmitting information about the size of the vehicle.

In another exemplary embodiment, the availability information is received from a parking infrastructure comprising parking sensors.

In another exemplary embodiment, the electronic controller is further configured to transmit payment information from the vehicle for occupying the available parking space.

In another exemplary embodiment, the parking infrastructure corresponds to infrastructure of at least one of a parking lot, a parking garage, a parking meter, and a street surveillance system.

In another exemplary embodiment, the electronic controller is further configured to activate a mechanism to prevent others from occupying a reserved parking spot.

In another exemplary embodiment, a method includes receiving, by an electronic controller of a reservation system, a parking space request. The parking space request is received from a vehicle. The method also includes determining whether a parking space is available to fulfill the parking space request. The determining is based on availability information that is received from a parking infrastructure. The method also includes transmitting an indication to the vehicle based at least one the determining. The indication indicates whether a parking spot has been reserved to fulfill the parking space request.

In another exemplary embodiment, the receiving the parking space request includes receiving a destination of the vehicle.

In another exemplary embodiment, the receiving the parking space request includes receiving information about the size of the vehicle.

In another exemplary embodiment, the availability information that is received from a parking infrastructure that includes parking sensors.

In another exemplary embodiment, the method includes transmitting a confirmation that a space has been reserved.

In another exemplary embodiment, the parking infrastructure corresponds to infrastructure of at least one of a parking lot, a parking garage, a parking meter, and a street surveillance system.

In another exemplary embodiment, a system within a reservation system includes an electronic controller. The electronic controller is configured to receive a parking space request. The parking space request is received from a vehicle. The electronic controller is also configured to determine whether a parking space is available to fulfill the parking space request. The determining is based on availability information that is received from a parking infrastructure. The electronic controller is also configured to transmit an indication to the vehicle based at least on the determining. The indication indicates whether a parking spot has been reserved to fulfill the parking space request.

In another exemplary embodiment, the receiving the parking space request includes receiving a destination of the vehicle.

In another exemplary embodiment, the receiving the parking space request includes receiving information about the size of the vehicle.

In another exemplary embodiment, the availability information is received from a parking infrastructure that includes parking sensors.

In another exemplary embodiment, the electronic controller is further configured to transmit a confirmation that a space has been reserved.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1(a) illustrates an example system for assisting vehicle parking in accordance with one or more embodiments;

FIG. 1(b) illustrates another example system for assisting vehicle parking in accordance with one or more embodiments;

FIG. 2 illustrates an architecture for a system for assisting vehicle parking in accordance with one or more embodiments;

FIG. 3 illustrates a flow chart of a method, performed by an infrastructure sensor system, in accordance with one or more embodiments;

FIG. 4 illustrates a flow chart of a method, performed by a vehicle, in accordance with one or more embodiments;

FIG. 5 depicts a flowchart of a method in accordance with one or more embodiments;

FIG. 6 depicts a flowchart of another method in accordance with one or more embodiments; and

FIG. 7 depicts a high-level block diagram of a computing system, which can be used to implement one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

When a driver of a vehicle is searching for a parking space to park the vehicle, the driver may have difficulty finding a suitable parking space. The driver may have difficulty finding a suitable parking space because the driver typically has a limited viewing angle when seated in the driver's seat. Therefore, because the field of vision of the driver is limited, the driver is unable to effectively see the possible parking options.

Further, even if the vehicle is equipped with sensors that can detect the presence of available parking spaces, the driver of the vehicle will still have difficulty finding a suitable parking space because the sensors (e.g., camera/radar/LIDAR systems) also have a limited field of view. Further, the view of the sensors can often be blocked by different obstructions.

In view of the above-described difficulties in finding a suitable parking space, one or more embodiments can configure infrastructure sensors to assist in finding suitable parking spaces. Infrastructure sensors can be sensors that are positioned at or near infrastructure that accompanies parking spaces. Such infrastructure can include infrastructure of parking lots, parking garages, parking meters, and/or street surveillance systems, for example. Infrastructure sensors generally have a view that is sufficient for effectively finding available parking spaces. One or more embodiments are directed to a system that assists drivers (and also assists autonomous vehicles) to find available parking spaces. One or more embodiments can reserve a parking space for an approaching vehicle while the approaching vehicle is still a far distance away from the reserved parking spot.

One or more embodiments can efficiently allocate parking spaces to vehicles, and one or more embodiments can keep track of the available parking spaces. One or more embodiments can be implemented at low cost if sensors are already present at an infrastructure.

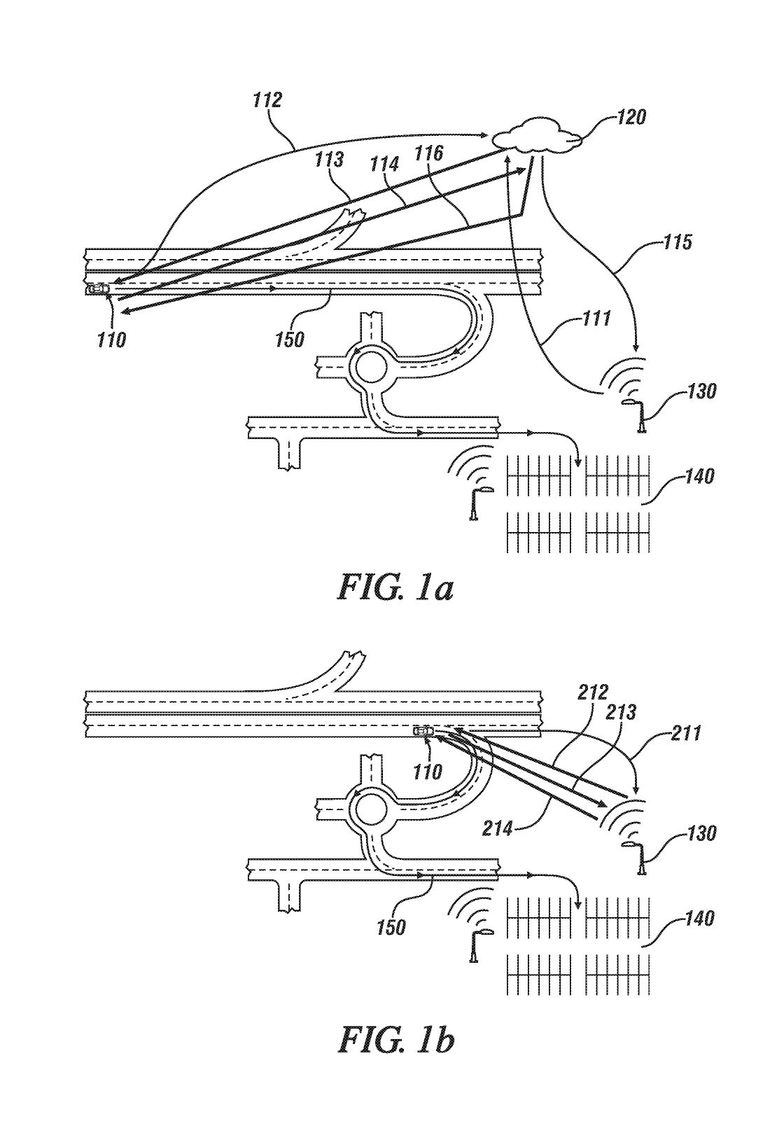

FIG. 1(a) illustrates an example system for assisting vehicle parking in accordance with one or more embodiments. In the example of FIG. 1(a), a cloud interface system 120 is configured to function as a reservation system for vehicle 110. Specifically, cloud interface system 120 is configured to reserve a parking space for vehicle 110, as described in more detail herein.

In the example embodiment of FIG. 1(a), an infrastructure sensor system 130 can transmit availability information 111 regarding parking spaces (of a parking destination 140) to cloud interface system 120. Cloud interface system 120 can be a cloud-based system, for example. Availability information 111 can include, but is not limited to, information regarding which parking spaces are available for parking, information regarding the characteristics of available parking spaces (i.e., the size of the spaces, whether spaces are handicap accessible, etc.), the costs associated with parking within the parking spaces, and/or any other relevant information that a driver may wish to know about the parking space. Infrastructure sensor system 130 can continuously update cloud interface system 120 by continuously transmitting availability information to cloud interface system 120. Infrastructure sensor system 130 can communicate with cloud interface system 120 via a cellular and/or a WIFI network, for example.

In the example of FIG. 1(a), a vehicle 110 is seeking a parking space that is located at parking destination 140. The vehicle 110 can transmit a parking space request via a vehicle-to-infrastructure communication 112 to cloud interface system 120. Communication 112 can be transmitted via WiFi communication and/or via a cellular network, for example. The vehicle 110 can transmit the parking space request for a parking space at destination 140 while the vehicle 110 is still a far distance away from the destination 140.

The parking space request 112 can include information about the size of the vehicle to be parked, the parking destination that is sought, and/or any other special preferences of vehicle 110. As cloud interface system 120 receives the parking space request 112, cloud interface system 120 can determine whether the parking space request can be fulfilled. Cloud interface system 120 can determine whether the parking space request can be fulfilled based on the transmitted availability information 111. Cloud interface system 120 can transmit available parking space information 113 to the vehicle 110. With one or more embodiments, the available parking space information 113 can include one or more options for parking that meet the criteria of the parking space request 112 of vehicle 110. With another embodiment, when multiple parking spaces that meet the criteria of the vehicle 110 are available, cloud interface system 120 can determine a space to reserve based on: (1) reducing a distance between the reserved parking space and a destination to be reached by a passenger in vehicle 110 (i.e., to reduce a walking distance to a store or restaurant), and/or (2) reducing an amount of traffic congestion at the predicted time/destination of arrival. If there are no options for parking that meet the criteria of the parking space request, the available parking space information 113 can inform the vehicle 110 that the parking space request needs to be modified in order to find an available space.

If vehicle 110 accepts one or more options for parking (that are presented to vehicle 110 by cloud interface system 120 via available parking space information 113), then the vehicle 110 can transmit an acceptance to interface system 120 via an indication of parking occupancy/payment confirmation 114. This indication can also include payment of any necessary fees for parking in the designated parking space.

Cloud interface system 120 can transmit a request 115 to infrastructure sensor system 130. Request 115 can comprise a request to reserve the designated parking spot for vehicle 110. As such, infrastructure sensor system 130 can operate in conjunction with parking destination 140 to block any other vehicles from occupying the space.

For example, once infrastructure sensor system 130 receives the request to reserve the designated parking spot, infrastructure sensor system 130 can trigger a variety of methods to reserve the designated parking spot. In one embodiment, the infrastructure system can activate a light indicator that is associated with the parking spot to inform other drivers that the designated parking spot has been reserved. Other embodiments can activate a gate or other mechanism to prevent others from occupying the reserved parking spot. With other embodiments, each available parking spot can be associated with an indicating sound that informs others drivers that the designated parking spot has been reserved. With other embodiments, a specific area of the parking lot can be designated for use by drivers that have reserved a parking space via the online reservation system. With other embodiments, infrastructure sensor system 130 can be configured to recognize vehicle plate numbers, and the infrastructure sensor system 130 can confirm whether each parking space has been occupied by a valid vehicle.

The cloud interface system 120 can also transmit a reservation confirmation 116 to the vehicle 110. Reservation confirmation 116 can include specific driving directions and/or coordinates to arrive at the reserved parking space. In one or more embodiments, the provided directions/coordinates can be specific enough to guide the vehicle 110 directly to the reserved parking spot (as opposed to merely guiding the vehicle to the listed address of the destination). Vehicle 110 can then follow path 150 to the reserved parking space.

With one or more embodiments, cloud interface system 120 can notify vehicle 110 of an available parking space that cannot be reserved for vehicle 110. For example, cloud interface system 120 can notify vehicle 110 of a public parking space that can be occupied by any driver for free. With this example, cloud interface system 120 does not transmit any reservation confirmation to vehicle 110. Rather, with one or more embodiments, cloud interface system 120 can provide an estimation of the likelihood that the parking space will remain available for the vehicle 110.

FIG. 1(b) illustrates another example system for assisting vehicle parking in accordance with one or more embodiments. In the example embodiment of FIG. 1(b), vehicle 110 is in relatively close proximity to infrastructure sensor system 130. Because vehicle 110 is in relatively close proximity to infrastructure sensor system 130, vehicle 110 can use short range communication to communicate with infrastructure sensor system 130 directly. In the example of FIG. 1(b), infrastructure sensor system 130 is configured to function as a reservation system for vehicle 110. Specifically, infrastructure sensor system 130 is configured to reserve a parking space for vehicle 110, as described in more detail herein.

Vehicle 110 can transmit a parking space request 211 to infrastructure sensor system 130. Infrastructure sensor system 130 can then determine whether the parking space request 211 can be fulfilled. Infrastructure sensor system 130 can then transmit available parking space information 212 to the vehicle 110. If vehicle 110 accepts one or more options for parking (that are presented to vehicle 110 by infrastructure sensor system 130 via available parking space information 212), then the vehicle 110 can transmit an acceptance to infrastructure sensor system 130 via an indication of parking occupancy/payment confirmation 213. Finally, infrastructure sensor system 130 can transmit a reservation confirmation 214 to the vehicle 110. Reservation confirmation 214 can also include specific driving directions 150 and/or coordinates to arrive at the reserved parking space.

With one or more embodiments, infrastructure sensor system 130 can notify vehicle 110 of an available parking space that cannot be reserved for vehicle 110. For example, infrastructure sensor system 130 can notify vehicle 110 of a public parking space that can be occupied by any driver for free. With this example, infrastructure sensor system 130 does not transmit any reservation confirmation to vehicle 110. Rather, with one or more embodiments, infrastructure sensor system 130 can provide an estimation of the likelihood that the parking space will remain available for the vehicle 110.

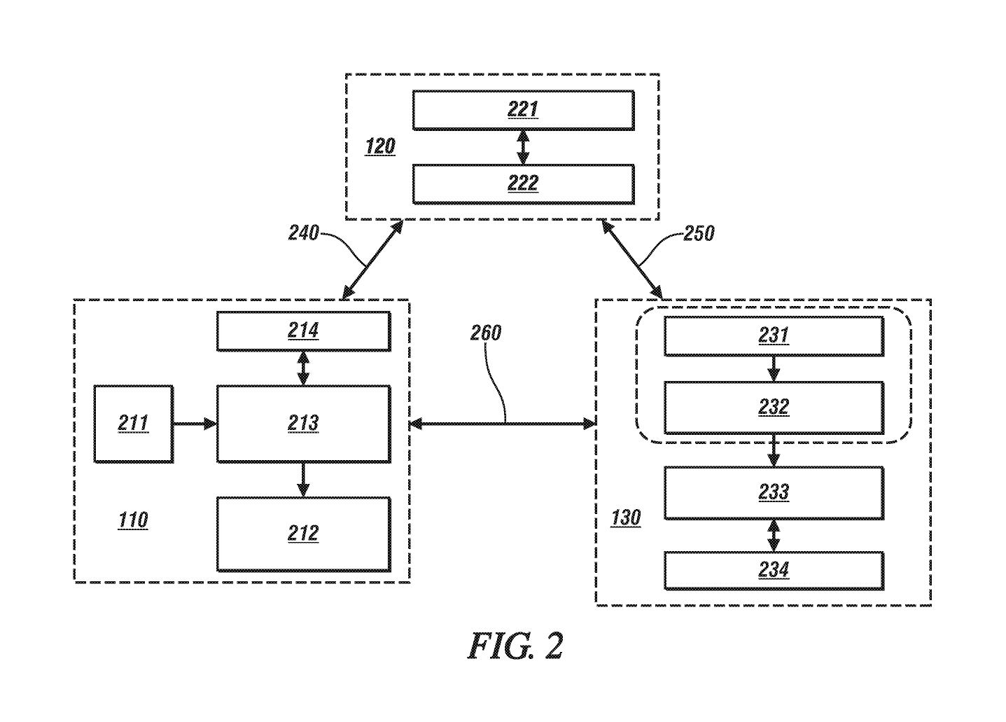

FIG. 2 illustrates an architecture for the system for assisting vehicle parking in accordance with one or more embodiments. Within vehicle 110, a vehicle sensor 211 (which can include global-position-system functionalities, a camera, a light detection and ranging (LIDAR) system, and/or a radar system) can assist in locating the vehicle. As described above, vehicle 110 can receive geographical coordinates/directions from cloud interface system 120 and/or an infrastructure sensor system 130. By using vehicle sensor 211, one or more embodiments can assist vehicle 110 by using the received coordinates/directions to route a path 150 between vehicle 110 and destination 140.

Within vehicle 110, a driver or autonomous driving module 212 can determine whether vehicle 110 is a human-driven or an autonomous vehicle. A user interface 213 is configured to receive information from the vehicle 110 to form the above-described parking space request. As described above, the information that is received by user interface 213 can include information about the size of the vehicle, the destination of the vehicle, and/or any other special preferences of the vehicle, for example. User interface 213 can also function as an autonomous trajectory planning module to display/determine the appropriate path 150 that is to be followed by an autonomous vehicle 110.

Telematics module 214 (of vehicle 110) can be used to communicate with cloud interface system 120 via communication 240. With one or more embodiments, telematics module 214 can communicate with infrastructure sensor system 130, as described in more detail herein. Telematics module 214 can communicate with cloud interface system 120 via a cellular network and/or a WIFI network, for example. Telematics module 214 can communicate with telematics module 221 to transmit/receive any of parking space request 112, available parking space information 113, and/or parking occupancy/payment confirmation 114. Multiple infrastructure information fusion 222 can combine different information between different infrastructures and transmit the combined information to vehicle 110.

Telematics module 221 (of cloud interface system 120) can be used to communicate with infrastructure sensor system 130 via communication 250. Telematics module 221 can communicate with infrastructure sensor system 130 via a cellular network and/or a WIFI network, for example. Telematics module 221 can communicate with telematics module 234 to transmit/receive any of parking space request 115 and/or availability information 111.

A sensing system 231 of infrastructure sensor system 130 can be used in conjunction with parking space detection module 232 to monitor the parking spaces to determine any available spaces. A parking space scheduling module 233 can be configured to coordinate between requests and parking spaces to more efficiently match the requests and the parking spaces.

With one or more embodiments, telematics module 214 and telematics module 234 can communicate with each other via short-range communication 260. The short-range communication 260 can be dedicated short range communications (DSRC) or WIFI communication. The short-range communication can be payment information and/or guidance information for vehicle 110. As described above, vehicle 110 can communicate directly with infrastructure sensor system 130 using short-range communications.

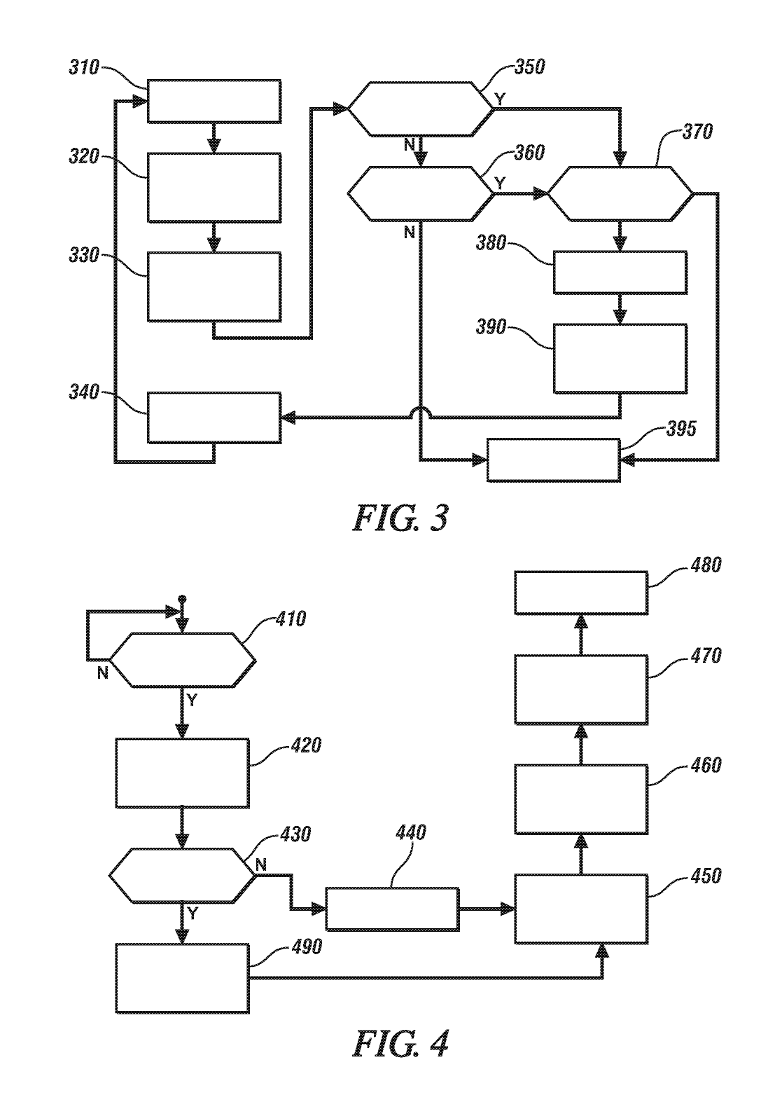

FIG. 3 illustrates a flow chart of a method, performed by an infrastructure sensor system, in accordance with one or more embodiments. The method, at 310, reads data from infrastructure sensors. This data can include camera/radar imagery that is captured by sensors positioned at the infrastructure. The method, at 320, applies machine-learning algorithms to process the camera/radar imagery. By processing the camera/radar imagery, one or more embodiments can detect whether parking spaces are available. One or more embodiments can also estimate a size and orientation of each available parking space. The method, at 330, updates the status of each parking space. Parking spaces that are unoccupied and not yet reserved by any vehicle are considered to be “available.” However, a parking space that is unoccupied but already reserved by an incoming vehicle is considered to be “pending but not expired” as opposed to “available.” A parking space that is “pending but not expired” has already been reserved and thus cannot be reserved by any other vehicle until a holding time expires. Specifically, once a parking space is reserved by a vehicle, the reserving vehicle holds the unoccupied parking space for a particular period of time. If the vehicle does not occupy the reserved parking space within the particular period of time, then the holding time expires and the status of the reserved parking space will change from “pending but not expired” to “available.”

The method, at 350, determines whether a parking request has been received from cloud interface system 120, for example. If no parking request has been received from the cloud interface system 120, at 360, one or more embodiments determines if a parking request has been received from a vehicle. If no parking request has been received from a vehicle, at 395, the request is rejected.

If a parking request is received from a cloud interface system (at 350) or if a parking request is received from a vehicle (at 360), then, at 370, one or more embodiments determines if any parking space is available. If no parking space is available, then, at 395, the request is rejected. If a parking space is available, at 380, one or more embodiments are configured to communicate with the vehicle to complete a payment process if the available parking space is not a free parking space. The method, at 390, assigns an available parking space based on the request and updates the status of the parking space to be “pending but not expired” with a holding/expiration time. One or more embodiments display an indication at the parking space to prevent unauthorized vehicles from occupying the space. The method, at 340, transmits the available parking space information to the cloud interface system and/or to the vehicle.

FIG. 4 illustrates a flow chart of a method, performed by a vehicle, in accordance with one or more embodiments. The method can be performed by vehicle 110, for example. The method, at 410, determines whether a parking space is needed by the vehicle. If a space is needed, at 420, one or more embodiments can prepare a parking space request, which includes any special requests such as requests relating to accommodation for a disability, for example. The method, at 430, determines whether the vehicle is in proximity to the infrastructure sensor system of the desired parking location. If the vehicle is not in proximity to the infrastructure, then one or more embodiments send a request though long-range communication to the cloud interface system at 440. The vehicle, at 450, then receives accurate information relating to the parking space. The information may be information regarding the position and/or orientation of the parking space. The method, at 460, determines a trajectory/path from the vehicle's current location to the parking spot. The method, at 470, confirms the transaction and payment with the cloud interface system and/or infrastructure sensor system. The method, at 480, transmits the determined trajectory/path to a driving module (of an autonomous vehicle) or to a display that can be viewed by the driver of the vehicle. At 430, if the vehicle is in proximity to the infrastructure sensor system, the method, at 490, sends a request via short range communication to the infrastructure sensor system.

One or more embodiments can include infrastructure components that perform functionality relating to sensing available parking spaces, reserving parking spaces, allocating parking spaces to vehicles, and/or notifying vehicles owners whether parking spaces are available for them.

The systems implemented within infrastructure and/or within the vehicles can perform methods and implement algorithms for estimating when and where parking spaces will be available, performing reservations based on requests received from vehicle drivers, and allocating available parking spaces to vehicles in an optimal manner.

One or more embodiments can predict the availability of one or more parking spaces based on historical patterns, requests received from other vehicles, and a current number of available spaces. If the prediction determines that no parking spaces are likely to be available, the cloud system can notify the appropriate vehicles.

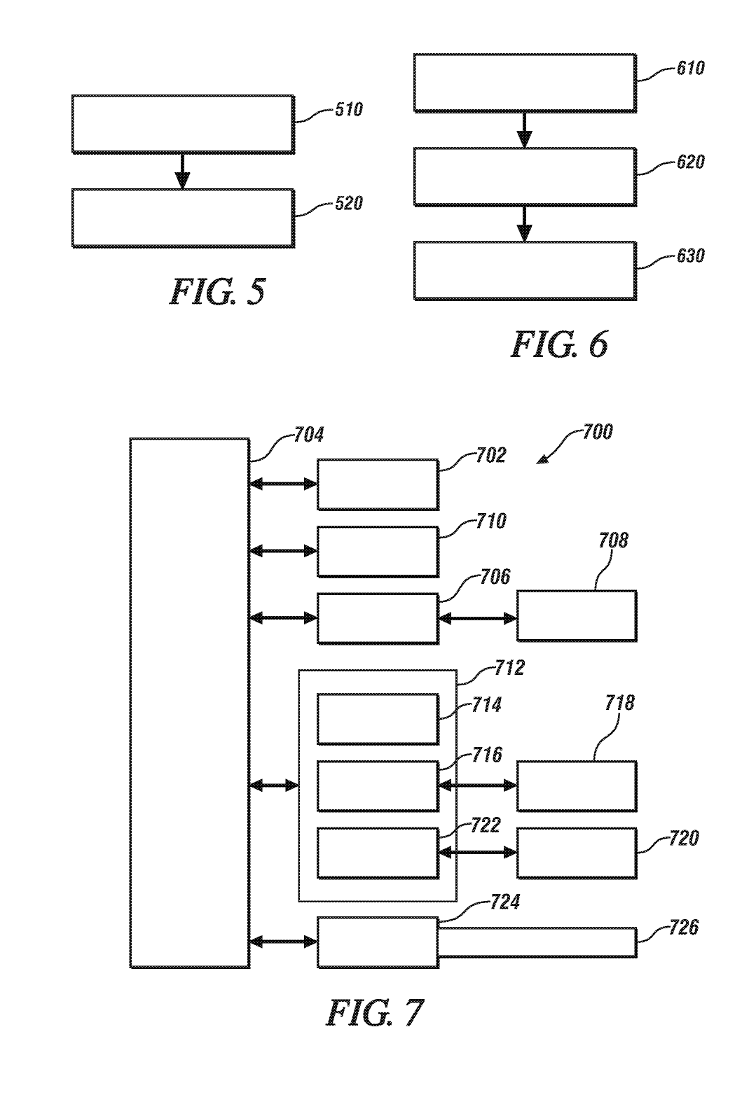

FIG. 5 depicts a flowchart of a method in accordance with one or more embodiments. The method can include, at block 510, transmitting, by an electronic controller of a vehicle, a parking space request. The parking space request is transmitted to a reservation system. The reservation system determines whether a parking space is available to fulfill the parking space request. The determining is based on availability information that is received from a parking infrastructure. The method can also include, at 520, receiving an indication. The indication indicates whether a parking spot has been reserved to fulfill the parking space request.

FIG. 6 depicts a flowchart of a method in accordance with one or more embodiments. The method can include, at block 610, receiving, by an electronic controller of a reservation system, a parking space request. The parking space request is received from a vehicle. The method can include, at block 620, determining whether a parking space is available to fulfill the parking space request. The determining is based on availability information that is received from a parking infrastructure. The method can also include, at block 630, transmitting an indication to the vehicle based at least on the determining. The indication indicates whether a parking spot has been reserved to fulfill the parking space request.

FIG. 7 depicts a high-level block diagram of a computing system 700, which can be used to implement one or more embodiments. Computing system 700 can correspond to, at least, an electronic controller of a vehicle, as described above, for example. Computing system 700 can also correspond to, at least, an electronic controller of an infrastructure sensor system and/or a cloud interface system, for example. Computing system 700 can be used to implement hardware components of systems capable of performing methods described herein. Although one exemplary computing system 700 is shown, computing system 700 includes a communication path 726, which connects computing system 700 to additional systems (not depicted). Computing system 700 and additional system are in communication via communication path 726, e.g., to communicate data between them.

Computing system 700 includes one or more processors, such as processor 702. Processor 702 is connected to a communication infrastructure 704 (e.g., a communications bus, cross-over bar, or network). Computing system 700 can include a display interface 706 that forwards graphics, textual content, and other data from communication infrastructure 704 (or from a frame buffer not shown) for display on a display unit 708. Display unit 708 can correspond to at least a portion of a dashboard of a vehicle, for example. Computing system 700 also includes a main memory 710, preferably random access memory (RAM), and can also include a secondary memory 712. There also can be one or more disk drives 714 contained within secondary memory 712. Removable storage drive 716 reads from and/or writes to a removable storage unit 718. As will be appreciated, removable storage unit 718 includes a computer-readable medium having stored therein computer software and/or data.

In alternative embodiments, secondary memory 712 can include other similar means for allowing computer programs or other instructions to be loaded into the computing system. Such means can include, for example, a removable storage unit 720 and an interface 722.

In the present description, the terms “computer program medium,” “computer usable medium,” and “computer-readable medium” are used to refer to media such as main memory 710 and secondary memory 712, removable storage drive 716, and a disk installed in disk drive 714. Computer programs (also called computer control logic) are stored in main memory 710 and/or secondary memory 712. Computer programs also can be received via communications interface 724. Such computer programs, when run, enable the computing system to perform the features discussed herein. In particular, the computer programs, when run, enable processor 702 to perform the features of the computing system. Accordingly, such computer programs represent controllers of the computing system. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the embodiments not be limited to the particular embodiments disclosed, but will include all embodiments falling within the scope of the application.

What is claimed is:

1. A method, the method comprising:
transmitting, by an electronic controller of a vehicle, a parking space request, wherein the parking space request is transmitted to a reservation system, the reservation system determines whether a parking space is available to fulfill the parking space request, and the determining is based on availability information that is received from a parking infrastructure; and
receiving an indication, wherein the indication indicates whether a parking spot has been reserved to fulfill the parking space request.

2. The method of claim 1, wherein the transmitting the parking space request comprises transmitting a destination of the vehicle.

3. The method of claim 1, wherein the transmitting the parking space request comprises transmitting information about the size of the vehicle.

4. The method of claim 1, wherein the availability information is received from a parking infrastructure comprising parking sensors.

5. The method of claim 1 further comprising transmitting payment information from the vehicle for occupying the available parking space.

6. The method of claim 4, wherein the parking infrastructure corresponds to infrastructure of at least one of a parking lot, a parking garage, a parking meter, and a street surveillance system.

7. The method of claim 1, further comprising activating a mechanism to prevent others from occupying a reserved parking spot.

8. A system within a vehicle, comprising:
an electronic controller configured to:
transmit a parking space request, wherein the parking space request is transmitted to a reservation system, the reservation system determines whether a parking space is available to fulfill the parking space request, and the determining is based on availability information that is received from a parking infrastructure; and
receive an indication, wherein the indication indicates whether a parking spot has been reserved to fulfill the parking space request.

9. The system of claim 8, wherein the transmitting the parking space request comprises transmitting a destination of the vehicle.

10. The system of claim 8, wherein the transmitting the parking space request comprises transmitting information about the size of the vehicle.

11. The system of claim 8, wherein the availability information is received from a parking infrastructure comprising parking sensors.

12. The system of claim 8, wherein the electronic controller is further configured to transmit payment information from the vehicle for occupying the available parking space.

13. The system of claim 11, wherein the parking infrastructure corresponds to infrastructure of at least one of a parking lot, a parking garage, a parking meter, and a street surveillance system.

14. The system of claim 8, wherein the electronic controller is further configured to activate a mechanism to prevent others from occupying a reserved parking spot.

15. A method, the method comprising:
receiving, by an electronic controller of a reservation system, a parking space request, wherein the parking space request is received from a vehicle;
determining whether a parking space is available to fulfill the parking space request, wherein the determining is based on availability information that is received from a parking infrastructure; and
transmitting an indication to the vehicle based at least on the determining, wherein the indication indicates whether a parking spot has been reserved to fulfill the parking space request.

16. The method of claim 15, wherein the receiving the parking space request comprises receiving a destination of the vehicle.

17. The method of claim 15, wherein the receiving the parking space request comprises receiving information about the size of the vehicle.

18. The method of claim 15, wherein the availability information is received from a parking infrastructure comprising parking sensors.

19. The method of claim 15 further comprising transmitting a confirmation that a space has been reserved.

20. The method of claim 18, wherein the parking infrastructure corresponds to infrastructure of at least one of a parking lot, a parking garage, a parking meter, and a street surveillance system.
